(19) United States
(12) Patent Application Publication
(10) Pub. No.: US 2026/0275727 A1
(43) Pub. Date: Sep. 17, 2026

(54) ARCHITECTURAL PANEL SYSTEM AND METHOD OF USE

(71) Applicant: LOUISIANA-PACIFIC CORPORATION, NASHVILLE, TN (US)

(72) Inventors: JUSTIN HOFFMANN, SUPERIOR, WI (US); BRIAN ST. GERMAIN, MT. JULIET, TN (US); LOUIS F. POLK, EXCELSIOR, MN (US); ETHAN JAMES OSCARSON, MINNEAPOLIS, MN (US)

(21) Appl. No.: 19/568,643

(22) Filed: Mar. 16, 2026

Related U.S. Application Data
(60) Provisional application No. 63/772,674, filed on Mar. 16, 2025.
(60) Provisional application No. 63/809,512, filed on May 21, 2025.
(60) Provisional application No. 64/003,778, filed on Mar. 12, 2026.

(51) Int. Cl. E04F 13/08; H02S 20/26

(52) U.S. Cl. CPC E04F 13/0805; H02S 20/26

(57) ABSTRACT

A system and related methods for affixing a plurality of architectural siding panels as the exterior or on the exterior of a structure, such as, but not limited to, a home, a residence, or a light commercial office building. The siding panels are of various sizes, typically rectilinear in shape, with a groove or slot running lengthwise in the panel edges. The panels are mounted on the walls, stud walls or studs by a combination of lightweight aluminum extrusions, hangers, and metal clips which engage the panel edges and/or grooves, as well as each other. The extrusions hold the siding panels away from and off of the structural or stud wall, thereby providing an integrated rainscreen and eliminating the need for “face-fastening” the siding panels. Corresponding solar panels may be used to substitute for one or more siding panels.

This application claims benefit of and priority to U.S. Provisional Applications Nos. 63/772,674, filed Mar. 16, 2025, 63/809,512, filed May 21, 2025, and 64/003,778, filed Mar. 12, 2026, all of which are incorporated herein in their entireties by specific reference for all purposes.

### FIELD OF INVENTION

This invention relates to an architectural panel siding system for use as exterior siding or cladding for a residential or light commercial structure.

### BACKGROUND OF THE INVENTION

Building wall and roof assemblies are commonly comprised of layers of several materials, each performing a specific function, that are installed separately. A typical assembly for residential home construction would include a dimension lumber frame, a plywood or oriented strand board (OSB) sheathing layer and a siding. In some cases, the sheathing and siding can be the same layer, such as a panel siding that is code approved as a sheathing. Wood-based composites, such as OSB, have been found to be acceptable alternatives to veneer-based wood paneling (e.g. softwood plywood) and dimension wood products.

In general, wood-based composites include, but are not limited to, oriented-strand board (OSB), wafer board, flake board, particleboard, and fiberboard (e.g., medium density fiberboard, or MDF). These wood-based composites are typically formed from a wood element (e.g., flake, strand, particle, wafer) combined with a thermosetting adhesive to bind the wood substrate together. In some processes, other additives are added to impart additional properties to the wood composites. Additives may include fire retardants, fungicides, mildewcides, insecticides, and water repellents. A significant advantage of strand and particle-based wood composites is that they have many of the properties of plywood and dimensional lumber, but can be made from a variety of lower grade wood species, smaller trees and waste from other wood product processing. In addition, they can be formed into panels in lengths and widths independent of the size of the harvested timber. One class of wood-based composites products comprise multilayer, oriented wood strand panel products. These oriented-strand, multilayer composite wood panel products are composed of several layers of thin wood strands, which are wood particles having a length which is several times greater than their width. These strands are created from debarked round logs by placing the edge of a cutting knife parallel to a length of the log and then slicing thin strands from the log. The result is a strand in which the fiber elements are substantially parallel to the strand length. These strands can then be oriented on a mat-forming line with the strands of the outer face layers predominantly oriented in a parallel-to-machine direction, and strands in the core layer generally oriented perpendicular to the face layers (i.e., “cross-machine”) direction.

In one known commercial process, these mat layers are bonded together using natural or synthetic adhesive resins under heat and pressure to make the finished product. Oriented, multilayer wood strand panels of the above-described type can be produced with mechanical and physical properties comparable to those of commercial softwood plywood and are used interchangeably, such as for wall and roof sheathing. In certain types of construction, these wood-based panels (and other construction materials) may be required by building codes to meet certain durability requirements, such as fire, wind and water resistance.

Oriented, multilayer wood strand panels and similar products of the above-described type, and examples of processes for pressing and production thereof, are described in detail in U.S. Pat. Nos. 3,164,511, 4,364,984, 5,435,976, 5,470,631, 5,525,394, 5,718,786, and 6,461,743, all of which are incorporated herein in their entireties by specific reference for all purposes.

Engineered wood siding and trim are specialty grades of oriented strand board that may be attached over sheathing or directly to the wall framing (e.g. in place of sheathing). These products have enhanced properties to perform under exposed, exterior weathering applications. The enhancements may include, but are not limited to, the type and amount of adhesive, the addition of water repellants and preservatives and the application of a resin saturated paper overlay to one or more sides. Engineered wood siding or trim may also be used as a fencing product with appropriate modifications to the manufacturing process described above.

### SUMMARY OF THE INVENTION

In various exemplary embodiments, the present invention comprises a system and related methods for affixing a plurality of architectural siding panels as the exterior or on the exterior of a structure, such as, but not limited to, a home, a residence, or a light commercial office building. The siding panels are of various sizes, typically rectilinear in shape, with a groove or slot running lengthwise in the panel edges. The panels are mounted on the walls, stud walls or studs by a combination of lightweight aluminum extrusions, hangers, and metal clips which engage the panel edges and/or grooves, as well as each other. The extrusions hold the siding panels away from and off of the structural or stud wall (the distance may vary, but in several configurations the rainscreen gap is 10 mm), thereby providing an integrated rainscreen and eliminating the need for “face-fastening” the siding panels. Corresponding solar panels may be used to substitute for one or more siding panels.

### BRIEF DESCRIPTION OF THE DRAWINGS

FIG. 1 shows a perspective view of a wall section with panel siding components in accordance with various exemplary embodiment of the present invention

FIGS. 2A-B show a perspective and partial end view of a panel with grooves on all four edges.

FIGS. 3A-B show a perspective and partial end view of a panel with a groove on a single long edge (e.g., the bottom edge).

FIG. 4 shows an example of a first style of hanger with top spacer connected to a first style of extrusion connecting two panel ends.

FIG. 5 shows a perspective view of the hanger of FIG. 4.

FIG. 6 shows a perspective view and end view of the extrusion of FIG. 4

FIG. 7 shows an example of a second style of hanger without top spacer connected to a first style of extrusion connecting two panel ends.

FIG. 8 shows a perspective view of the hanger of FIG. 7.

FIG. 9 shows a perspective view and end view of the second style of extrusion.

FIG. 10 shows an end/cross-sectional view of a third style of extrusion.

FIG. 11 shows an example of an integrated hanger-extrusion style of hanger with spacer connecting two panel ends.

FIG. 12 shows a perspective view and end view of the integrated hanger-extrusion of FIG. 11.

FIG. 13 shows an example of a spacer between the ends of two extrusions.

FIGS. 14A-C show top views of examples of a vertical window or door spacer.

FIGS. 15A-D show top views of examples of connectors between adjacent ends of two panels

FIGS. 16-20 show top views of examples of inside corner connectors or spacers.

FIGS. 21-23 show top views of examples of outside corner connectors or spacers.

FIG. 24 shows a perspective partially exploded view of the positioning of standoff spacers behind panels.

FIG. 25 shows a detailed side view of the standoff spacers behind a panel connected to a wall with hangers and extrusions.

FIG. 26 shows a detailed side view of hidden fasteners securing a hanger behind a siding panel.

FIG. 27 shows a perspective view of a wall section with a combination of siding panels and solar panels.

FIG. 28 shows a perspective view of a solar panel.

FIG. 29 shows an example of solar panel wiring in the space behind the solar panels.

### DESCRIPTION OF EXEMPLARY EMBODIMENTS OF THE INVENTION

In various exemplary embodiments, the present invention comprises a system and related methods for affixing a plurality of architectural siding panels as or on the exterior of a structure, such as, but not limited to, a home, a residence, or a light commercial office building. The siding panels are of various sizes, typically rectilinear in shape, with a groove or slot running lengthwise in the panel edges. The panels are mounted on the walls, stud walls or studs by a combination of lightweight aluminum extrusions, hangers, and metal clips which engage the panel edges and/or grooves, as well as each other. Corresponding solar panels may be used to substitute for one or more siding panels.

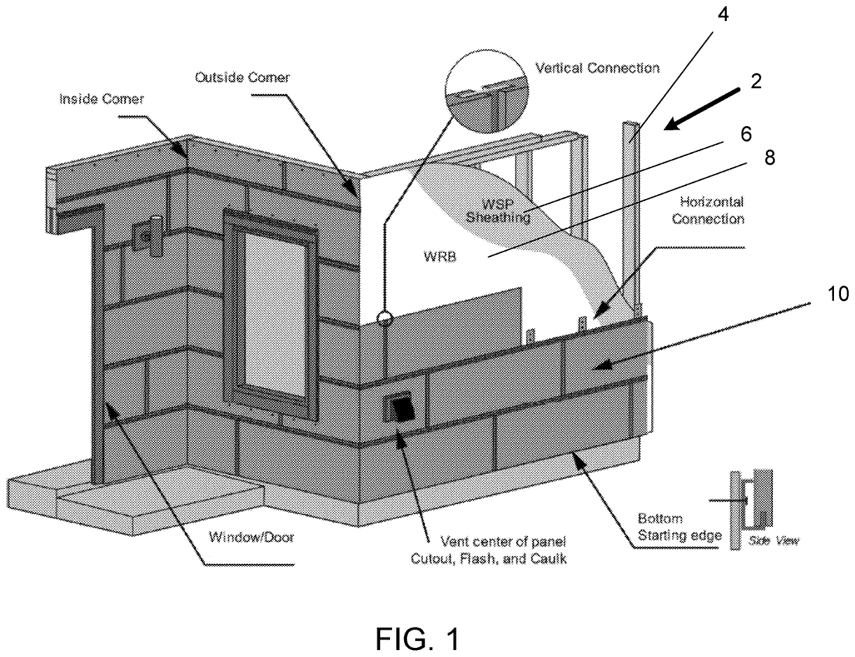

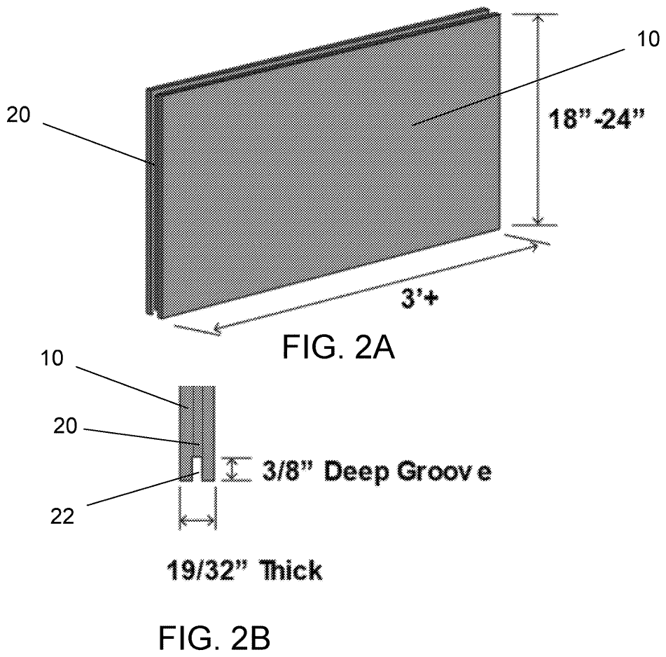

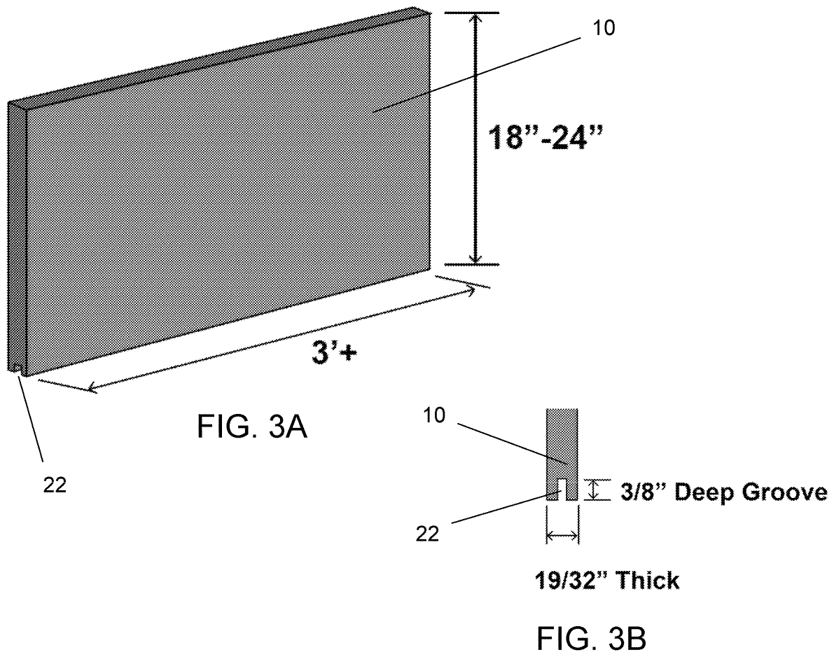

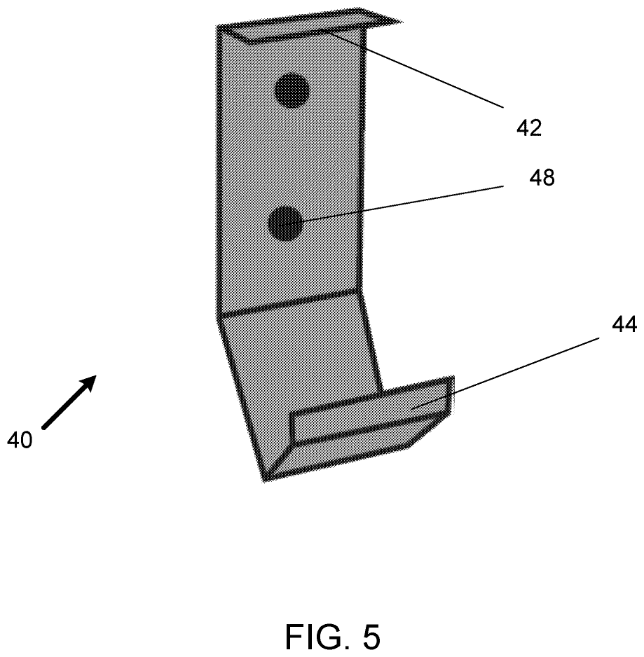

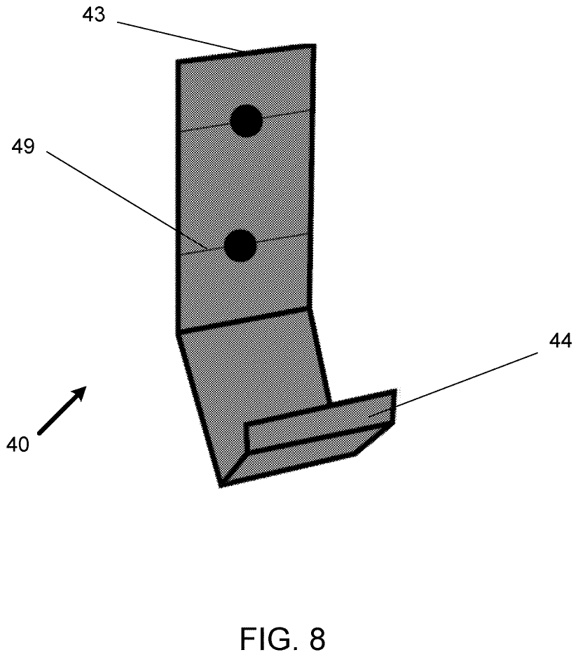

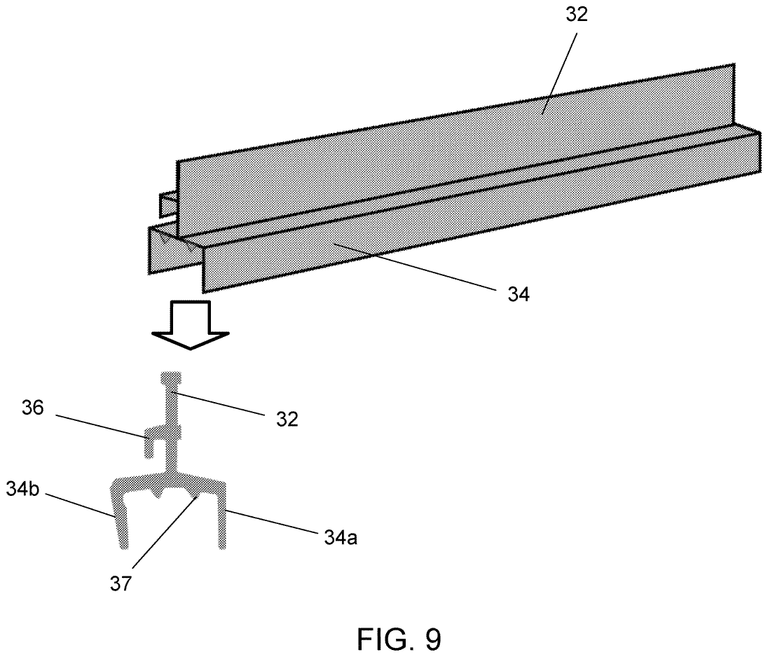

The extrusions hold the siding (or solar) panels away from and off of the structural wall or stud wall (the distance may vary, but in several configurations the rainscreen gap is 10 mm), thereby providing an integrated rainscreen and eliminating the need for “face-fastening” the siding panels. A rainscreen system is an exterior wall detail where an outer panel or layer is separated or stands off from the outer surface of an inner wall surface, panel or layer, usually moisture-resistant, thereby creating a capillary break and allowing drainage and evaporation of moisture in the air space or gap therebetween.) FIG. 1 shows an example of the system in progress of being installed on a structure with a structural wall or stud wall 2 comprising studs 4, sheathing panels 6 (typically a form of manufactured-wood, such as oriented-strand board or “OSB”), and a weather-resistant (or water-resistant) barrier overlay (“WRB”) 8. The siding panels 10 in this example are rectilinear, as seen in FIGS. 2-5 and 7-9. Grooves 20 may be deep cut or formed in the center or near-center of one or more of the edges of the panels. In one embodiment, each of the four edges of the panel has a groove. In an alternative embodiment, only one edge has a groove, typically a bottom edge groove 22 along the bottom or lower edge. In a further embodiment, three edges have a groove, e.g., the bottom or lower edge, and the adjacent side edges. While the figures herein show all panels having the same number of grooves, in several alternative embodiments panels may have different numbers and configurations of grooves depending on their location on the wall or structure, particular application and/or intended use.

In various embodiments, the panels 10 generally are 3 feet or greater in length, from about 18″ to about 24″ in width, and about 19/32″ in thickness, with edge grooves about ⅜″ deep cut or formed in the edges. These dimensions may vary depending on their location on the wall or structure, particular application and/or intended use.

Corresponding solar panels 12 may be used to substitute for one or more siding panels 10, as described below. Solar panels for the system generally have the same length and width dimensions to match the siding panels, although the thickness may be different. It should be understood that references hereto to a siding panel or siding panels should be construed to include corresponding solar panels or a solar panel, as described herein.

Panels are indirectly attached to the sheathing or stud wall by one or more hangers, extrusions, and/or clips. Hangers, extrusions, and clips may be individual pieces or components, or some may be integrated or combined together, such as the integrated hanger/extensions described below. The hangers, extrusions, and/or clips may be comprised of metal, plastic, similar materials, or combinations thereof. In a preferred embodiment, they are formed from aluminum, and may be provided in a variety of finishes and/or colors.

In one embodiment, the method or process of installation proceeds as follows. First, one or more extrusions 30 are placed horizontally (laterally) on the lower portion of the wall 2 as a starting row or point. The starting row extrusions may be one of the standard extrusions, or a special starter extrusion, as seen in FIG. 1. One or more siding panels 10 are positioned on these extrusions 30, with the bottom edge groove 22 fitting over and secured by a top vertical fin 32 (where a standard extrusion is used) or a bottom vertical extension (where a special extrusion or clip is used). Where the panels have grooves 20 in the vertical side edges, flat extrusions are placed inside the grooves vertically between the adjacent panels. As the first row is completed, another extrusion 30 is placed over the top of the first row panels, and fastened to the stud or structural wall 2, either directly or indirectly, such as by hangers 40, as described herein. The panels 10 in the second row are then placed on the corresponding top vertical fins 32 of the extrusions placed over the top of the lower row, with the bottom edge groove 22 fitting over the top fin. These steps are completed for subsequent rows, proceeding vertically up the wall.

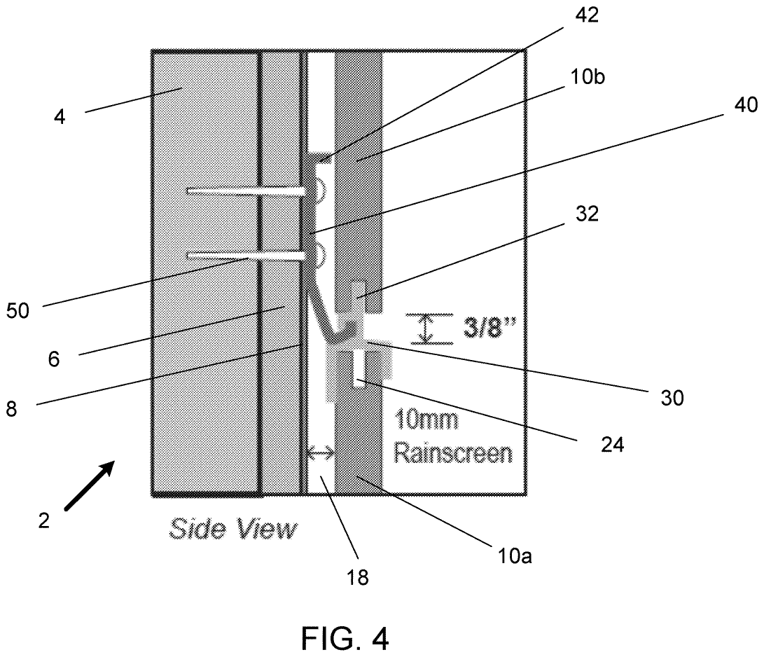

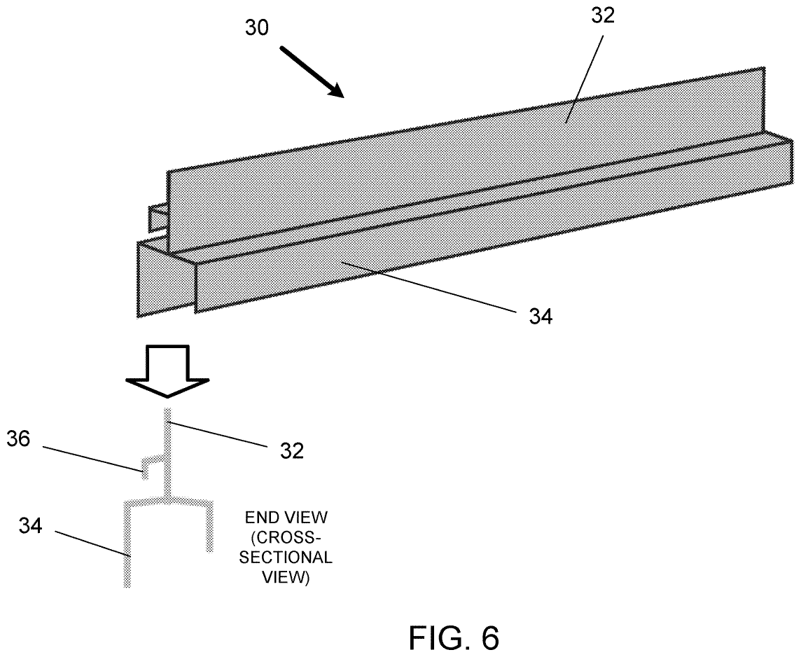

FIGS. 4-6 show an example of a two-part attachment configuration with a hanger 40 and a first style of extrusion 30. The hanger 40 is fastened to the wall 2 by fasteners 50 such as nails or screws, which are inserted through holes 48 in the back vertical portion of the hanger. These holes may be pre-drilled or may be drilled or punched through the hanger on the job-site. In the embodiment shown, the fasteners 50 penetrate through the sheathing panel 6 into the underlying stud 4.

The top 42 of the hanger extends horizontally, and can act as a horizontal spacer keeping the higher portion of the upper siding panel 10b off the wall. The extrusion 30 has a bottom that acts as a cap 34 over the top of the lower siding panel 10a, with a front flange and a back flange extending down the front face and back face of the panel, respectively, and sealing off the top of that panel, including any top groove 24 that may be present therein. A vertical fin 32 extends upward from the bottom cap 34 for insertion into the bottom edge groove 22 of the upper siding panel. A downward facing clip 36 extending from the back side of the vertical top fin serves a stop/support and/or spacer for the bottom of the upper siding panel and also receives the bottom attachment 44 of the hanger, which extends from the hanger and holds the extrusion and associated panel edges off the wall by a distance.

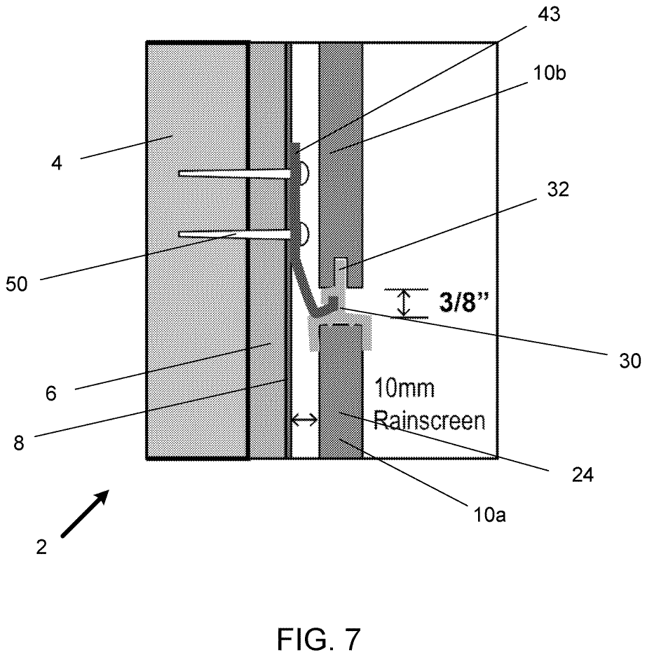

FIGS. 7-9 show another embodiment of the hanger and extrusion. The hanger in this embodiment ends with a top 42 that is co-planar with the back, and is without the horizontal spacer. The top may be flat from back to front, or angled downwards to promote water or fluid flow from the back to the front. Nail-lines or fastener lines 49 are scored or marked on the back face of the hanger to provide guides for locations where fastener holes may be placed. Even if holes are pre-drilled, the lines 49 extended horizontally across the face and can be used by the installer to ensure that hangers on installed on an even level. The bottom angle of the hanger may comprise one or more holes that allow water flow out of the bottom and continue down the air gap 18 behind the panel (this air gap also effectively provides a “rainscreen” for the construction).

The extrusion in this embodiment comprises one or more points or ridges extending from the top edge of the cup, typically for some or all of the length of the extrusion, which engage the top edge of the lower panel 10a. The back side 34b of the bottom cup is angled slightly inward as it extends from the back corner of the top edge of the cup. This angle applies inward pressure as the cup is inserted over the lower panel, which helps apply a “friction fit” and secure the panel edge within the cup. The front side 34a of the cup may be straight or slightly angled inward as well to apply pressure inward as well. In some embodiments, a slight extrusion or ledge may be located on the front of the top fin 32 at or near the same level with the top of the downward facing clip 36. This acts in concert with said clip to server as a support and/or stop for the bottom edge of the upper panel 10b. The top end of the top fin 32 also may be slightly larger than the main part of the fin, which helps the upper panel stay securely on the fin.

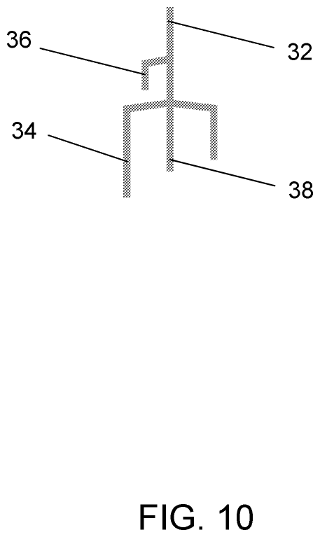

FIG. 10 shows a variation of the extrusion where a downward fin 38 within the bottom cap 34 is provided for insertion in a top groove 24 of a panel. This provides a more secure fit between the extrusion and the lower panel, and helps provide stability during installation.

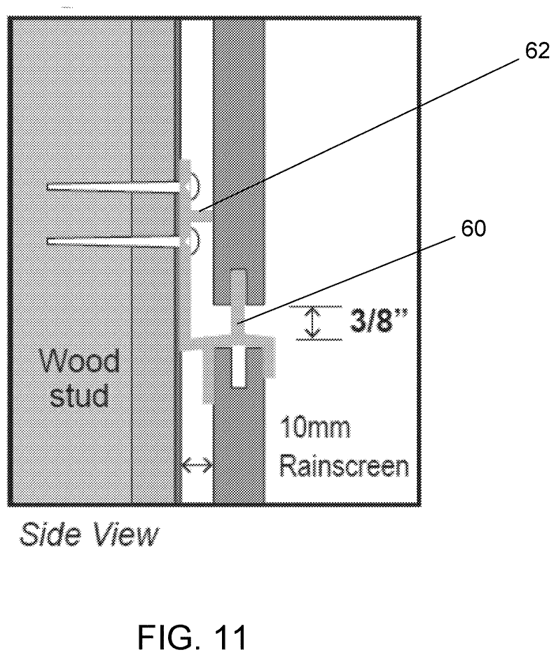

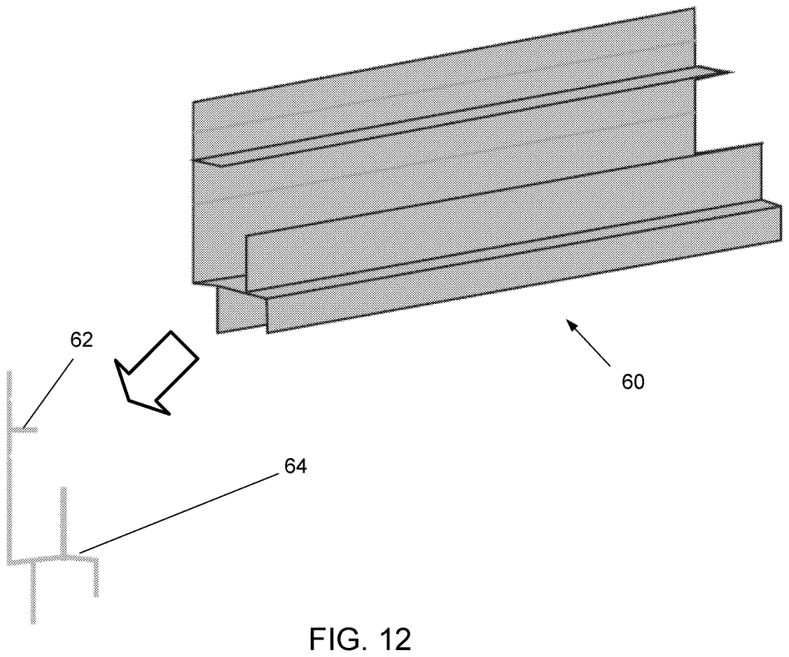

FIGS. 11 and 12 show an example of an integrated hanger/extrusion component 60. The respective “hanger” and “extrusion” elements of the integrated component function in the same ways and with similar or the same features as described above with regard to the various embodiments of separate hangers and extrusions, except that the integrated nature replaces the need for a connection through a back clip on the extrusion. That is, the part of the extrusion holding the edges of the associated panel edges is essentially the same as described above, but without the downward facing clip. The mounting part of the extrusion comprises a flat back face with two fastener lines for insertion of fasteners as described above. A horizontal spacer 62 extends outward from the back face to help keep the upper siding panel properly spaced and off the stud wall. The spacer may be located at different locations along the back. The top connection 64 between the cap element and the back face, and towards the front face, may be a slightly acute angle, which assists in holding the weight of the panels and may encourage water or fluid flow away from top to the front or back sides of the panel.

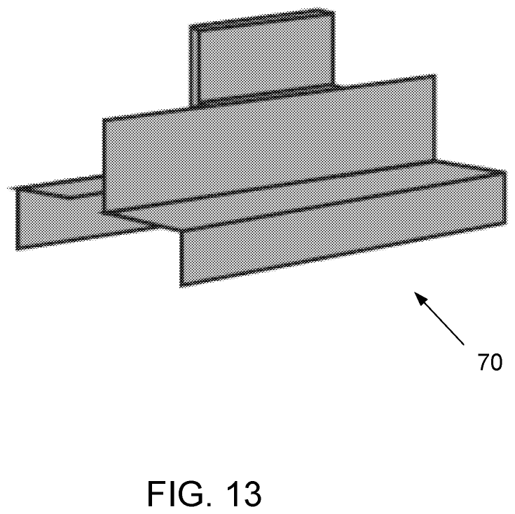

FIG. 13 shows a spacer 70 that may be used with panels between the ends of extrusions. These rest on the top edge of lower panel in a similar manner to the extrusions themselves, and cover the space between the extrusion ends.

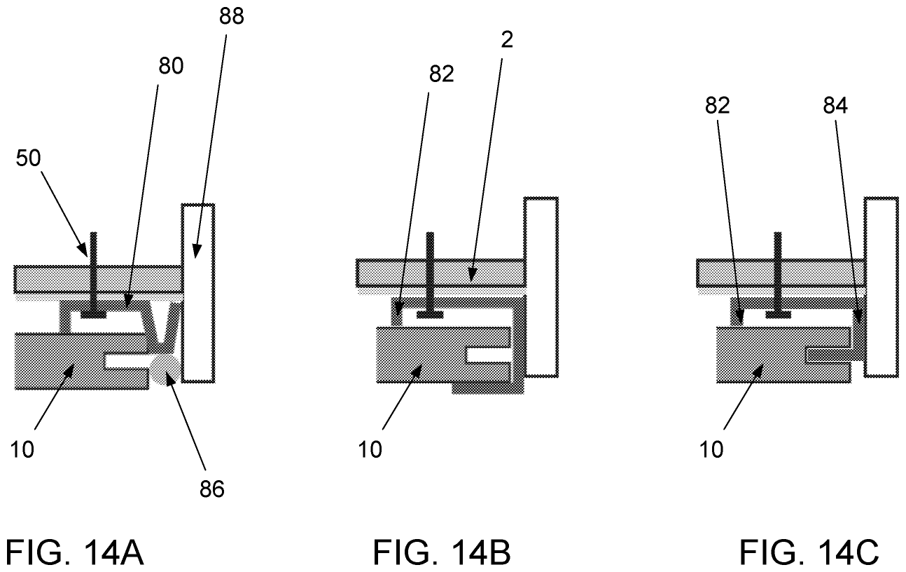

FIGS. 14A-C shows examples of various forms of metal clips 80 that may be used to engage and hold a panel 10 edge (which may be grooved or not grooved) in a space adjacent to a window or door (e.g., a window or door jamb). The clip 80 is fastened (such as by a nail 50 or other fastener) to the wall 2, has an interior vertical spacer 82 at one end to help keep the associated siding panel properly spaced and off the wall, while the other end 84 acts to keep the panel edge properly spaced and fixed in place with respect to the wall and the door/window jamb 88. Each arrangement seals the groove from water or other intrusion, either by extending in front of the panel (as seen in FIG. 14B), extending into the groove itself (as seen in FIG. 14C), or providing a space and platform for a bead or strip 86 of caulk, putty, or similar sealant (as seen in FIG. 14A).

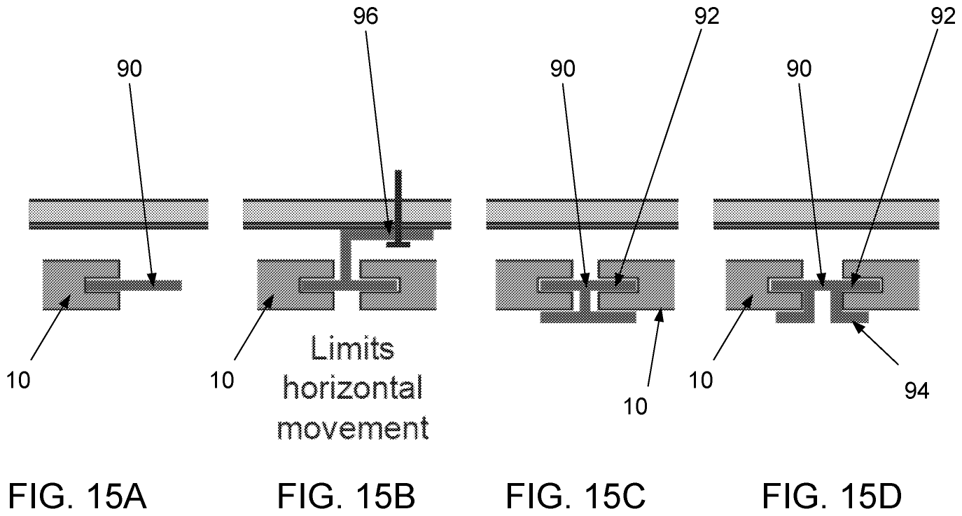

FIG. 15A-D shows similar examples of various forms of metal clips 90 that may be used to engage and connect two adjacent vertical panel edges. Each of these embodiments generally comprise a fin or similar element 92 configured to fit within the corresponding grooves. Variations include configurations to add a clip element 94 extending on the outward faces of the panels, or a fastening element 96 configured to secure the clip to the wall and studs, which also has the benefit of limiting horizontal movement of the clip and attached panels.

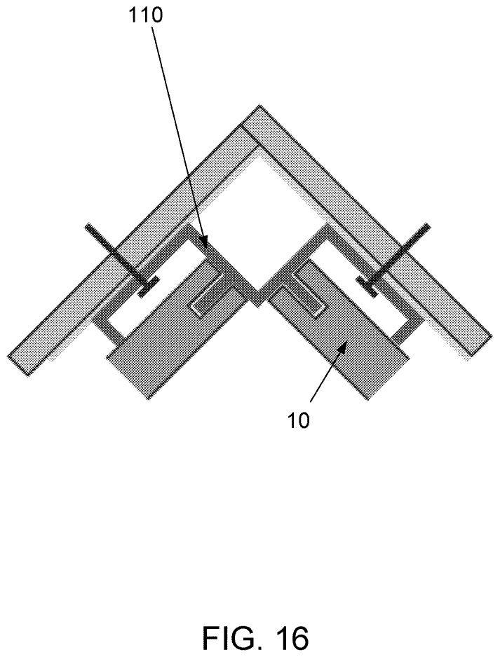

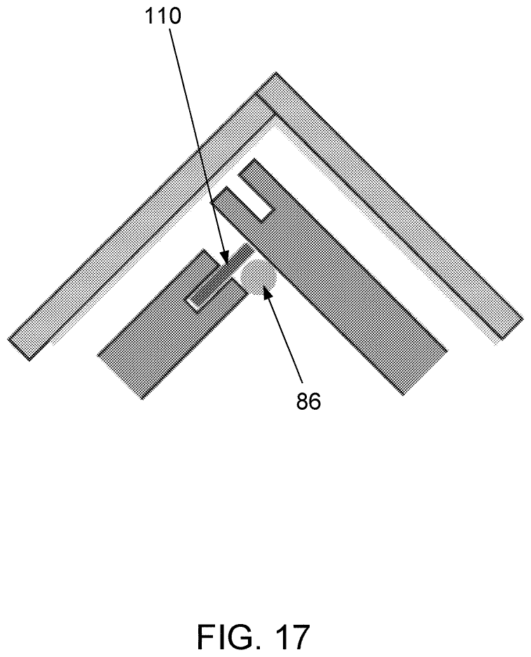

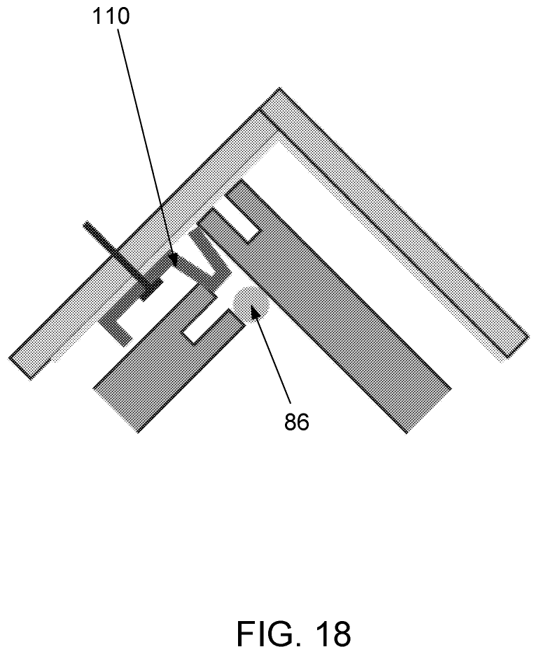

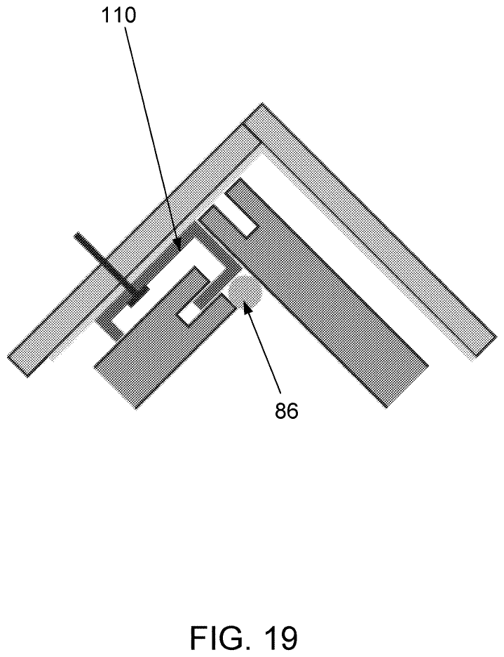

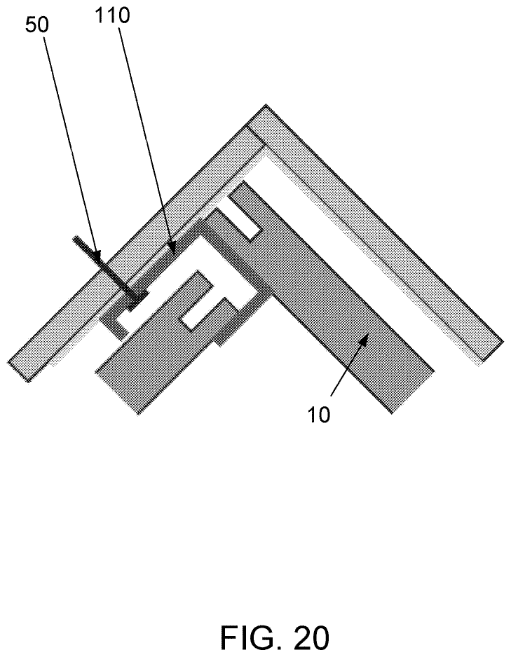

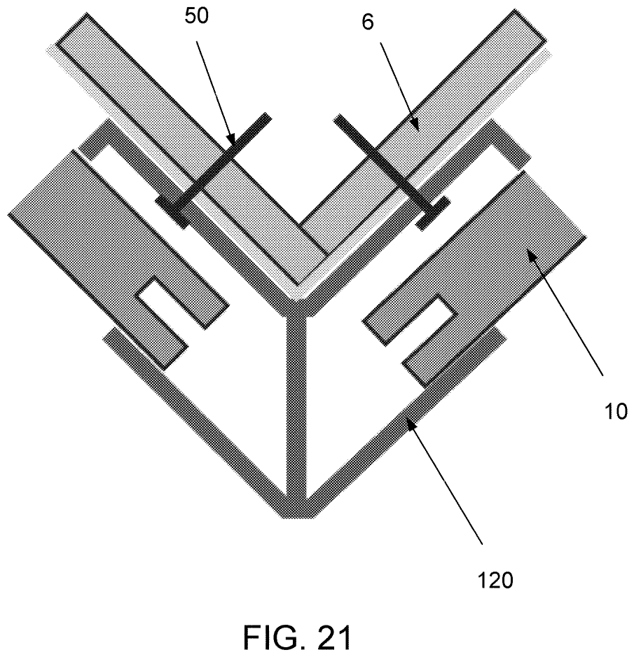

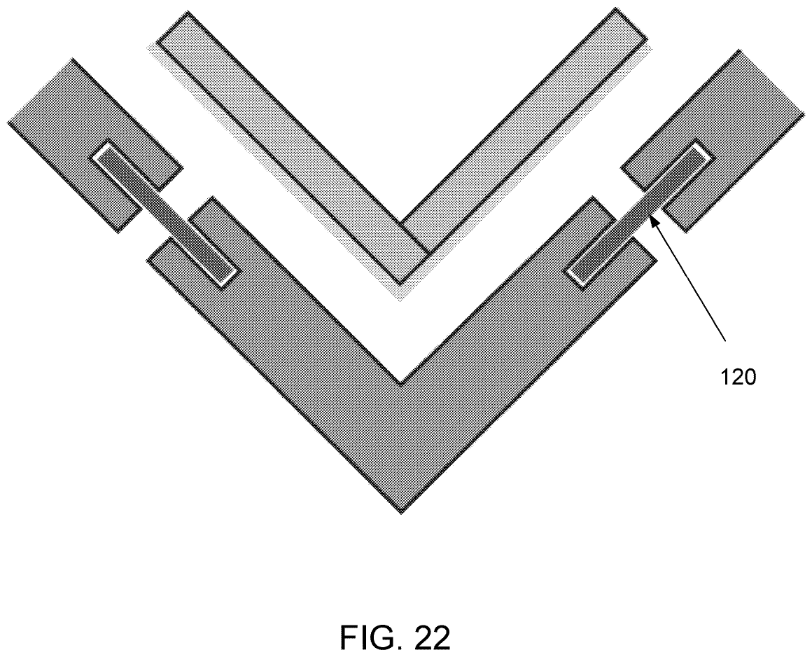

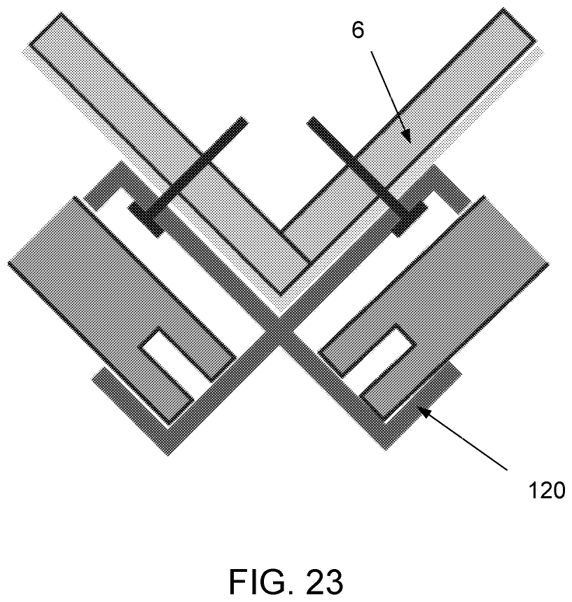

FIGS. 16-20 show examples of clips 110, some fastenable to the stud wall and studs, used to engage and connect two adjacent panel edges along inside corners. FIGS. 21-23 shows examples of similar clip 120 arrangements for outside corners.

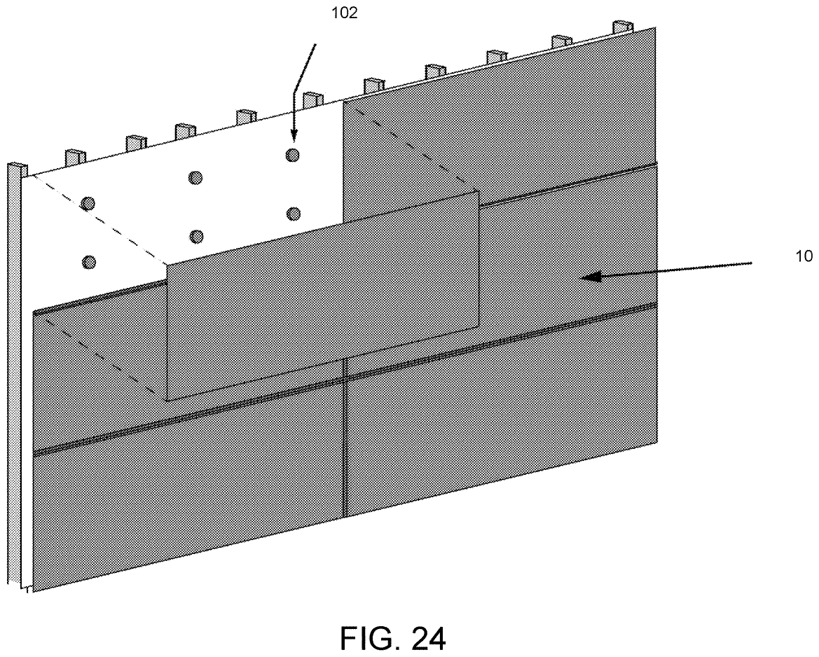

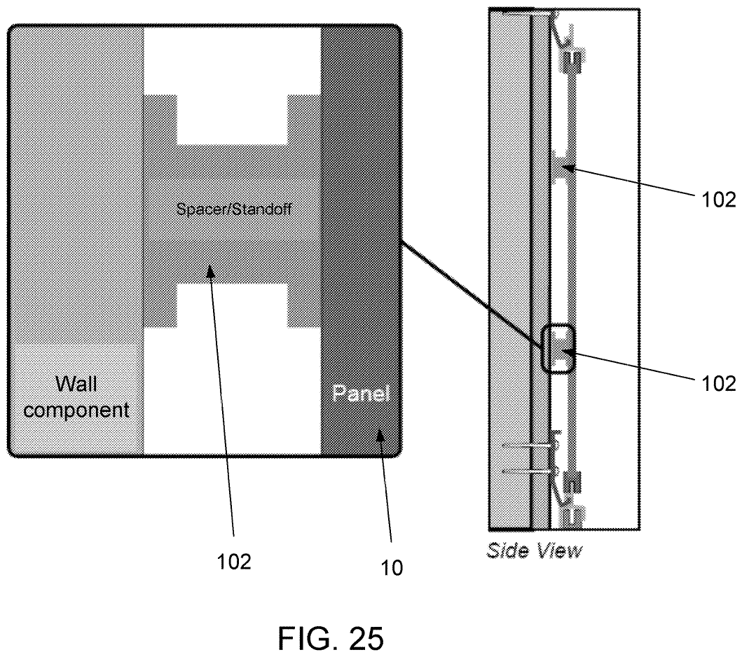

FIGS. 24-25 show examples of supporting spacers or standoffs 102 located behind the panels to ensure that the panels are spaced evenly from the wall 2 behind the panel. The spacers or standoffs 102 may comprise a single element, or two or more components. In an exemplary two-component embodiment, one component is affixed to the wall and the other component is affixed to the back of the panel, and the two components attach or join together during installation both to provide structural support and performance and to ensure the panels remain a consistent distance from the wall. The means for attaching or joining in various embodiments include, but are not limited to, matching hook-and-loop elements, pucks, cleats, or similar mechanical devices, which may be adhesively or mechanically secured to the wall and/or panel at specific intervals.

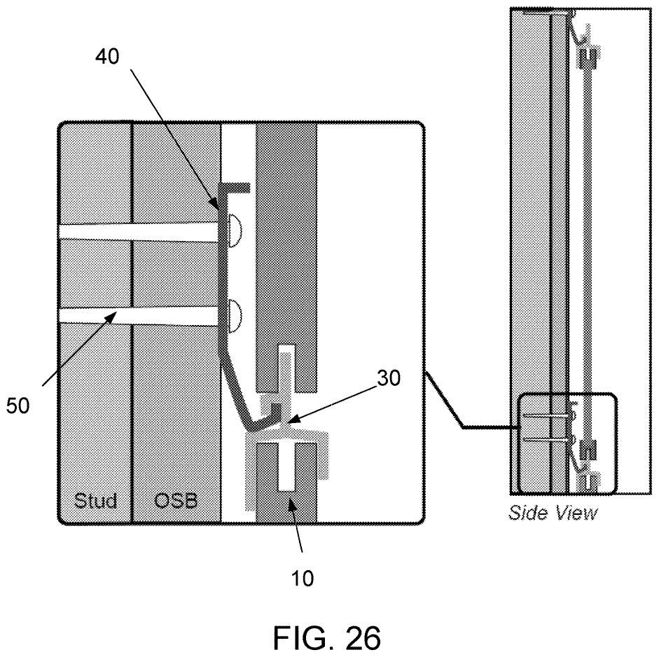

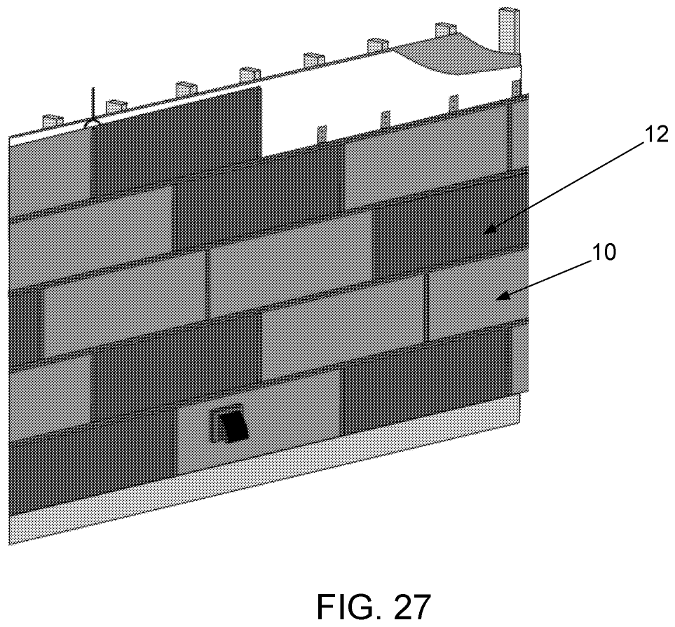

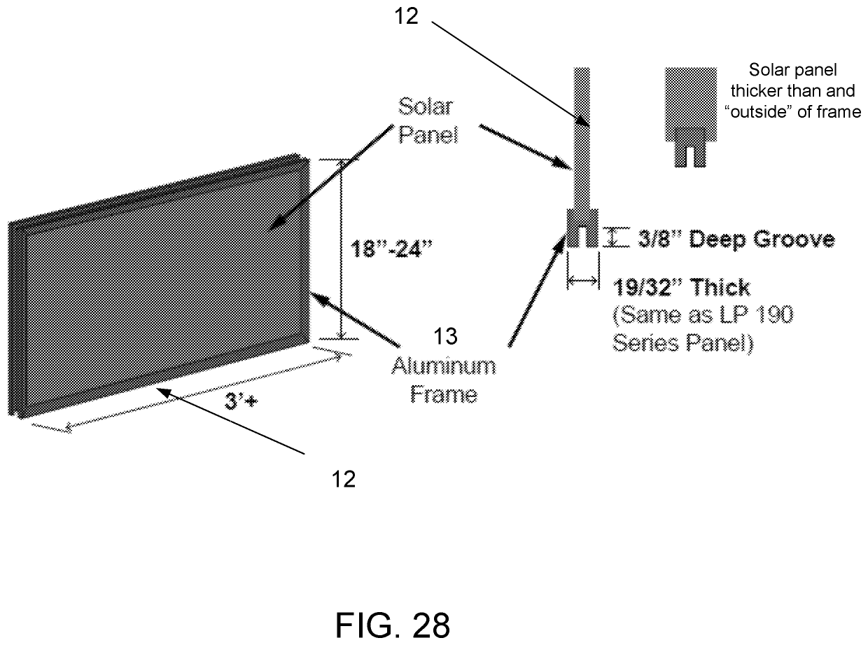

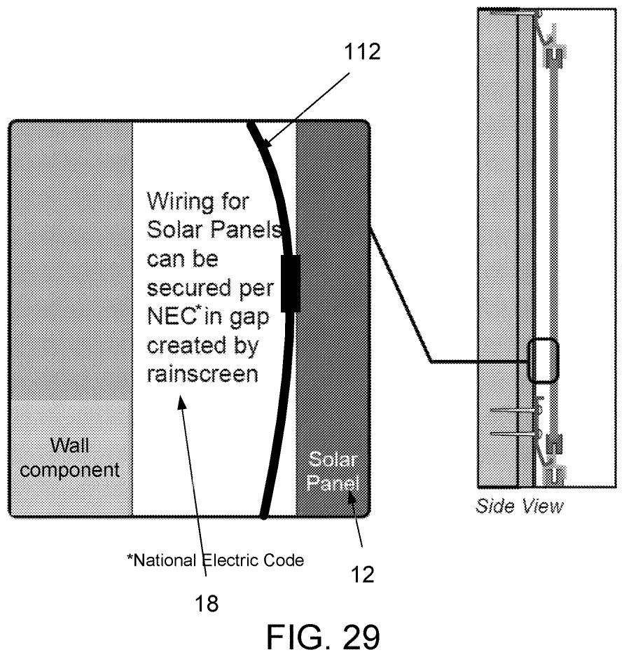

FIG. 26 shows an example of a “hidden” fastener 50 arrangement in accordance with another exemplary embodiments of the present invention. In the embodiment shown, the siding panels 10 are positioned and held by an extrusion 30 at both top and bottom edges, as described. Hangers 40 are screwed, nailed or attached directly to the wall components, including the stud underneath the OSB sheathing, and the bottom portion of the hanger forms a J shape that clips or fits within a corresponding clip on the back side of the extrusion, thereby supporting the extrusion and siding panels. Variations on this hander and extension configuration are described more fully above No portion of the fasteners 50 are visible from the front of the panels 10, and there are no direct fasteners penetrating the siding panels, thereby creating a “face fastener-less” siding panel system. In further exemplary embodiments, one or more of said panels 10 comprise solar panels 12 (i.e., panels that receive sunlight and other forms of light on one face and convert it to electricity). The solar panels may be thinner, thicker or the same thickness as the composite panels described above. The panels typically have an aluminum or similar frame 13 around the edges, which may be thicker or thinner than the panel, as seen in FIG. 28. As seen in FIG. 29, electrical wiring and connections 112 for the solar panels may be located and/or secured in the rainscreen gap 18 (i.e., behind the solar panels and composite panels).

The edges or frames 13 of each solar panel may have grooves as described above for the siding panels 10. In the embodiment shown in FIG. 28, an aluminum frame with an external deep groove for engaging components of the present system is affixed around the perimeter of the solar panel. The grooves and/or frame may be integrated with the solar panel during production, or may be retrofit to existing panels.

Accordingly, the system of the present invention provides a system of grooved panels and mating extrusions to create an easy-to-install and durable modern look on any commercial or residential building. A variety of color, size and trim options allow builders and architects the ability create a tremendous number of different appearances and looks, providing aesthetic diversity. The system uses lighter weight materials with longer lengths and more durability, along with blind and/or minimal fasteners, minimizing the need for touch-ups and keeping contractors moving quickly during installation. The integrated rainscreen creates a gap that promotes both airflow and moisture drainage in the gap. The system does not use fiber cement, and has a negative carbon footprint.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A architectural panel system, comprising:
a plurality of panels, each panel comprise a front side, a back side, a top edge, a bottom edge, and two side edges, with a groove in at least the bottom edge extending for a length of the bottom edge;
a plurality of extrusion edge holders, each comprising a lower end comprising a cap with a front flange and a back flange, and a top vertical fin extending upward, wherein said top vertical fin is configured to fit within the bottom groove edge of an upper panel from said plurality of panels, and said cap is configured to encompass the top edge of a lower panel from said plurality of panels such that the front flange extends down a portion of the front face of the lower panel and the back flange extends down a portion of the back face of the lower panel; and
a plurality of hangers, one or more hangers of said plurality of hangers connected to at least one of said plurality of extrusion edge holders and configured to be mounted on a wall of a structure by one or more fasteners;
wherein said panels are held and supported by corresponding hangers and extrusion edge holders at a distance from said wall and do not directly contact said wall or any of said one or more fasteners.

2. The system of claim 1, wherein when said plurality of panels are fully installed, no portion of any of said fasteners used in said installation are visible from the front of the panels.

3. The system of claim 1, wherein the plurality of panels comprise siding panels.

4. The system of claim 1, wherein the plurality of panels comprise engineered wood panels.

5. The system of claim 1, wherein the plurality of panels comprise one or more solar panels.

6. The system of claim 1, wherein the plurality of panels comprise two or more oriented strand board panels and one or more solar panels.

7. The system of claim 1, wherein the corresponding hangers and extrusion edge holders are integrally formed.

8. The system of claim 1, wherein each hanger is separate from the extrusion edge holders.

9. The system of claim 8, wherein each hanger forms a shape of a shape of a J, wherein the bottom of J shape is configured to connect to a downward facing clip on the back side of a corresponding edge holder.

10. The system of claim 1, wherein each hanger comprises two parallel fastener lines.

11. The system of claim 1, further comprising one or more spacers configured to extend between respective ends of adjacent extrusion edge holders.

12. The system of claim 1, wherein the bottom edge and each side edge of each panel comprises a groove.

13. The system of claim 1, wherein the top edge of each panel comprises a groove.

14. The system of claim 1, wherein the cap of each extrusion edge holder further comprises a downward fin positioned between the front flange and the back flange.

15. The system of claim 1, further comprising a plurality of outside corner clips configured to secure a side edge of a panel adjacent to an outside corner.

16. The system of claim 1, further comprising a plurality of inside corner clips configured to secure a side edge of a panel adjacent to an inside corner.

17. The system of claim 1, further comprising a plurality of clips configured to secure a side edge of a panel adjacent to a window or door jamb.

18. A method of installing an architectural siding system according to claim 1 on a wall, comprising the steps of:
(a) mounting a starter row of edge holders on a wall using corresponding hangers according to claim 1;
(b) placing a series of panels from said plurality of panels according to claim 1 on the starter row of edge holders;
(c) mounting a next higher row of extrusion edge holders according to claim 1 on the wall adjacent to the top edge of lower row of panels, such that each extrusion edge holder extends for at least a portion of the top edge of a panel in the lower row of panels;
(d) placing a series of panels from said plurality of panels according to claim 1 on the next higher row of extrusion edge holders; and
(e) repeating steps (c) and (d) with subsequent rows until the installation is complete;
wherein after installation is complete, the panels are held a pre-determined distance from the wall, and the panels do not touch the wall.
